(19) United States
(12) Patent Application Publication
(10) Pub. No.: US 2010/0131311 A1
(43) Pub. Date: May 27, 2010

(54) METHOD FOR MODIFYING THE TERMS OF A FINANCIAL INSTRUMENT

(76) Inventor: Daniel J. Parker, Chatham, NJ (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/275,550

(22) Filed: Nov. 21, 2008

(51) Int. Cl. G06Q 40/00; G06F 17/30

(52) U.S. Cl. 705/7; 705/35; 707/E17.044

(57) ABSTRACT

A method for modifying the terms of a financial instrument comprising the steps of obtaining organization data, obtaining weighting factors, transforming the organization data by the weighting factors via a computer to obtain an indicator and relating the terms of the financial instrument to the indicator, wherein the terms are determined from the indicator. The organization data is representative of political, economic, social, technological, legal, environmental, charitable, policy, financial and/or regulatory data. Weighting factors are obtained and quantified from perception polls, surveys, questionnaires, pick lists, votes, opinion polls and/or individual opinions. The organization data is then transformed by the weighting factors to obtain a indicator, wherein the indicator is the basis for obtaining the financial instrument or modifying the terms of the financial instrument.

### CROSS-REFERENCE TO RELATED APPLICATIONS

The present application is a related application to non-provisional patent application Ser. No. 12/182,561 entitled “METHOD FOR GENERATING A COMPUTER-PROCESSED FINANCIAL TRADABLE INDEX,” filed on Jul. 30, 2008, by inventors Daniel J. Parker and Erik Rothenberg, the entire contents of which being hereby incorporated by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The preferred embodiment relates generally to a method for modifying the terms of a financial instrument from a computer-generated indicator, and more specifically to a method that comprises the steps of obtaining organization data, obtaining weighting factors from an online community, weighting the organization data by the weighting factors to obtain the indicator, and relating terms of the financial instrument to the indicator.

2. Description of Related Art

Today's organizations are faced with new challenges, such as, global competition, unprecedented advancements in technology, changing regulations and global impact of local events. In this context, organizations are forced to extend efforts beyond short-term and quarterly financial demands, and satisfy a broader range of stakeholders. Organizations that commit acts causing deterioration of the planet's water, air and/or natural resources are increasingly being held accountable for such irresponsible behavior. Whether refusing to support social initiatives that uplift the human experience, or endorsing political efforts to place the interests of a few over the interest of the masses, specifically as it relates to our common resources, organizations are quickly realizing they are out of alignment and placing their business at risk.

Conversely, organizations, such as, governments, non-profit corporations, associations, academic institutions, for-profit corporations, varied-sized business, or subsidiaries that engage in responsible behavior are realizing that restoration of the planet, rebalancing climate, and uplifting of humanity are efforts that satisfy the collective consciousness, fulfill our obligations of stewardship, and are aligned with longevity and success.

Fortunately, organizations have recently come to the conclusion that self-interest policy, without a longer term view, can be harmful to shareholders and global stakeholders alike. For example, for years the auto industry lobbied against stricter fuel efficiency standards in the self interest of short-term gain without considering stakeholder sentiment. If these companies had allocated resources differently and considered policy resistance as empowerment opportunity, their current situation may be different.

Today, industries engage in quick fixes and hasty conformation to the masses at the risk of their very extinction. However, if certain financial instruments, such as bonds or loans, were contractually tied to an organization's P.E.S.T.L.E. (political, economic, social, technological, legal and environmental) performance (hereinafter “PESTLE”), such would provide for an alignment of interests and a possible lifeline. Accordingly, there is a need to attach financial rewards to those who comply and exceed community expectations, while penalizing those who do not value the planet as a common space.

To that end, community sentiment is the next generation tool for strategic planning and capitalization. The twenty-first century brings a new era of stewardship and competition related to social, environment and political values that society determines vital to every business because people will conduct business with those who share these values. Organizations that embrace good governance, and adhere to mandates, minimize adverse societal and environmental impact and are more likely to be sustainable over the long term. Such organizations should be rewarded for compliance, while those who do not should be penalized for non-compliance.

Generally, Corporate Social Performance (CSP) is a term used to describe behavior by an organization. For example, when an organization engages in environmental or other social performance, beyond what the law requires, and does so because it thinks the behavior will help shareholder returns, that is designated CSP. Of course, if it serves the shareholder, then it is perfectly reasonable behavior that management should engage in.

The financial crisis of 2008 created financial causalities in many sectors, in the form of fire sale acquisitions, shrinking tax rolls and bankruptcies. A reliance on government sponsored financial relief, thereby transferring market risk to taxpayers, was a conflicted concept based on exorbitant and excessive executive compensation, lack of diligent risk controls, and specific to this invention, disregard to social, environmental and policy mandate deemed important by the masses. It is clear that if the people are expected to bail out private enterprise, private enterprise must begin to abide by the “will of the people”.

The Internet has connected us and we have the technological capability to achieve consensus regarding what is important to us as a society. With this capability, also entrusts us to achieve a higher purpose for those of us today, and the future generations of tomorrow.

Since the world has finite resources, determining what allocation best serves mankind and having the ability to measure our progress seems intuitive. However, identifying variables such as social impact on the environment and economy are only the first step. Today, we are provided on opportunity to create a new paradigm and a new way of measuring performance whereby all stakeholders' interests are aligned. There is a cultural mandate causing PESTLE performance to be established recorded, measured and rewarded.

“Sustainable Development” is a common theme among many people today. But how do we define our goals and know if we are succeeding? How do we know if we are aligned with the interests and expectations of stakeholders? Is there a method to compare industries, or individual organizations on a relative or absolute basis? How do we, as a community, measure the impact? Is it possible to incentivize organizations without imposing legislative or regulatory mandates?

The purpose for reporting is to help us reach a particular end state: sustainability. Sustainability defined is the creation of a socio-economic system that can be “sustained” over time. Sustainability is a concept that refers to “development that meets the needs of the present without compromising the ability of future generations to meet their own needs.” This includes social impact such as labor, education, living standards and population. This includes economic impacts such as employment, equity and consumption. This includes environmental impacts such as, natural resources, pollution and externality risks.

When applied to companies, sustainability involves conducting business so as not to negatively affect long-term viability, shareholder value, the environment or stakeholders (including consumers, employees and local communities).

Both investors and consumers are increasingly interested in a company's sustainability and many companies have responded by improving their disclosure of business policies, practices, goals, and challenges related to political, environmental and social issues. A sustainability report provides a means for companies to report sustainability indicators and address sustainability issues.

Although reporting is a step in the right direction, selectively choosing companies to monitor is important, but not comprehensive. The next phase of financial market-based sustainability includes a method of leveraging our technologies that connect humans, whereby a collective consciousness dictates: what variables lead us to sustainability, what weights and measures are should be assigned, how we attach our “sentiment” to financial instruments to incentivize organizations and align shareholders, lenders, investors, and stakeholders alike.

A collective consciousness provides visibility for people to make informed choices and reciprocates to organizations to react to those choices in the form of organizational actions.

As a world society, it is our responsibility to direct our governments, corporations and associations to a collective consciousness. The framework provides a method for achievement of climate balance, restoration of the earth and uplifting humanity.

The ability to act in accordance with the values of society and linked to financial incentive is the crossroads of our time.

As such, the next-generation of financial to societal correlation is a direct contractual link to yield and governance through PESTLE performance in order to provide benchmarks and incentives between financial instruments offered/issued by organizations.

Organizations that aspire for longevity care about community sentiment because such interaction increases customer acquisition, provides for measurement of best practices and offers deep insight into attitudes. If one were to assume that financial motivation is the key driver for responsible organizational governance, then attaching financial incentives as the surrogate mandate, one would need look no farther than the financial markets.

Currently, there are several methods available to evaluate financial instruments. For example, financial indexes, such as, the Dow Jones Industrial Average and the S&P 500 Composite Stock Price Index, evaluate stocks from major industries of the United States economy. Such indexes provide many benefits, such as, providing transparency and offering common reference points for the purpose of trading. However, these existing financial models have only traditionally considered risks, such as business liability, model execution, and direct competitive threat, but have not considered, nor mitigated, actual or relative performance of PESTLE data and/or other variables that are considered important to society, such as, water conservation, recycling, volunteerism, and the like.

Currently, there are indexes such as Dow Jones Sustainability Indexes and FTSE 4 Good Indexes that track the financial performance of the leading sustainability-driven companies. The companies are internally analyzed and represent a select group of organizations worldwide in pre-selected industries.

Therefore, it is readily apparent that there is a need for a method for modifying the terms of a financial instrument for the purpose of procuring and rebalancing financial instruments that is aligned with both shareholder value and societal and environmental success.

### BRIEF SUMMARY OF THE INVENTION

Briefly described, the preferred embodiment overcomes the above-mentioned disadvantages and meets the recognized need for such a method for modifying the terms of a financial instrument. A computer-generated indicator is utilized to originate the terms of the financial instrument, and to subsequently modify the terms of the financial instrument based on a subsequent revision to the indicator.

The indicator is a measurement based in part on PESTLE variables and is utilized to determine what is important to society, what questions drive community sentiment, what weights are attached to sentiment and the variability of consensus and performance data. The indicator is also a value reflecting the potential of an organization to achieve the objectives of climate balance, Earth restoration and uplifting humanity. This indicator becomes a basis for multiple embodiments of market design and human consciousness directed in a matter that supports such objectives.

The indicator, for exemplary purposes only, may be a score, an index and/or a rating. The indicator as a score is an event driven numerical system that tracks the progress of a single individual and/or entity. The score may be an incremental notch based on performance, a numerical record of a competitive event, a total number of points made by a participant (either at a final point in time or at a given stage), a numerical result of a test and/or examination, and the like.

The indicator as an index is an aggregation of multiple components into an alphanumeric value. The index may be, for exemplary purposes only, an orderly arrangement of keywords and/or other data (enabling users to identify information quickly and efficiently), a computation of more than one variable combined into a numerical valuation, a statistical measurement of performance of an organization converted to a single number, a single number calculated from an array of prices and/or quantities, and/or from a aggregation of more than one individual, entity or stock, and the like.

The indicator as a rating is a grading system based on a known scale, such as, for exemplary purposes only, a position assigned on an alphanumeric scale based on past performance of a single individual and/or entity, a rating from an alphanumeric value disclosed as the results of an evaluation of an organization's past actions and/or history representing the likelihood of similar future results, or an evaluation of an organization's suitability based on past performance. Changes to the rating are the result of positive or negative actions of organizations and may be utilized as an alphanumeric value representing an individual, organization or national interest to describe a time snapshot of past history.

A financial instrument is a contractual assurance to repay in the form of a promissory note, a bill of exchange, a credit facility, a bond, a debenture, a loan, an instrument of indebtedness, and the like. A loan, for exemplary purposes only, is an arrangement in which a lender gives money and/or property to a borrower. The borrower agrees to return the property and/or repay the money, usually along with interest at some future point(s) in time.

A bond is an interest-bearing, discounted, government or corporate security that obligates the issuer to pay the bond holder at a specified sum of money, usually at specific intervals, and to repay the principal amount of the loan at maturity. A bond may be, for exemplary purposes only, a floating-rate bond or a municipal bond. A floating-rate bond is a bond that changes periodically based on some predetermined benchmark, such as the spread above a yield on a six-month Treasury security. A municipal bond is a bond issued by a state, city or local government.

Terms of financial instruments typically include any of the following: Leverage ratio, duration, redemption terms, conversion terms, maturity, refunds, escrow terms, calling terms, penalties, interest rate, payment acceleration, reserves, roll-over, principal, and the like.

In a preferred embodiment, the indicator is based on PESTLE variables, wherein weighting factors are obtained from community sentiment and processed as a means of contributing to the generation of a numerical value to determine the terms of a financial instrument and/or settle other ancillary financial products, such as, for exemplary purposes only, exchange-traded funds, options, futures and/or the like.

In another embodiment, financial instruments, debt structures and/or credit facilities, such as, for exemplary purposes only, credit lines, utilize an indicator system, wherein the indicator is tied to incremental value and event-driven thresholds of the financial instrument.

In yet another embodiment, PESTLE variables are generated by a voting community, or through a processed survey, wherein an indicator is generated and forms the basis for setting terms of a financial instrument.

In yet another embodiment, an organization is eligible for an indicator, wherein a consolidation of organization indicators is utilized for exchange-traded funds that utilize PESTLE scores as the basis for incremental value and benchmarking.

In another embodiment, the indicator is selectively utilized as an index benchmark for exchange-traded financial instruments or exchange-traded funds that utilize the indicator alone or in a combination with other indicators.

According to its major aspects and broadly stated, the preferred embodiment is a method for modifying the terms of a financial instrument, comprising obtaining organization data, obtaining weighting factors, weighting the organization data by the weighting factors utilizing a computer to obtain the indicator, and relating the terms of the financial instrument to the indicator.

The organization data is typically obtained from independent parties, organizations themselves, indexes and data that represents indexes. The organization data is typically representative of political data, economic data, social data, technological data, legal data, environmental data, charitable data, policy data, regulatory data and/or financial data. The organization data may also be descriptive of variables that are deemed valuable to society, such as, for exemplary purposes only, water usage, educational goals, recycling and volunteerism.

Additionally, the organization data is typically gathered from, for exemplary purposes only, corporations, non-profit organizations, associations, municipalities, governments, medium-sized businesses and/or subsidiaries. The organization data is selectively categorized into groups, divisions and/or regions, or alternatively, the organization data may be categorized into sizes, industries, sectors, and the like.

Weighting factors are obtained and quantified from an online community that provides a “wisdom of crowds” perspective to determine the key performance indicators utilized in obtaining the indicator. The weighting factors typically consist of responses to surveys, questionnaires, pick lists, votes, opinion polls, perception polls, individual opinions, and combinations thereof. The weighting factors are generated from at least one source located on a network or accessible via the Internet.

The indicator is derived by applying a weighting method to the organization data, wherein the weighting factors are utilized to adjust the organization data, and relate to the type of organization data being weighted. The weighting method selectively comprises a plurality of weighting conventions, such as, for exemplary purposes only, multiplication, division, addition, subtraction, exponentiation, and the like. The organization data and the indicator are directly received and aggregated into a computer server. The computer server includes a database and the server is utilized to transmit and receive data via the Internet. The indicator is derived from the organization data and the weighting factors, typically related to a fixed period of time.

Further, the preferred embodiment is a method for generating a new indicator from new organization data and new weighting factors, weighting the new organization data by the new weighting factors via a computer, thereby obtaining the new indicator. The new indicator is utilized to modify or create new terms for the financial instrument, wherein the new terms are determined from the new indicator. The new organization data typically comprises new political data, new economic data, new social data, new technological data, new legal data, new environmental data, new charitable data, new policy data, new regulatory data, new financial data, and combinations thereof. The new organization data may also be categorized into groups, regions and/or divisions. The new organization data may be selectively stored on a server and either directly accessed from the server, or alternatively, accessed from external sources via the Internet.

Additionally, the preferred embodiment is a method of comparing the indicator and the new indicator and modifying the financial instrument if the new indicator is outside a selected range. For instance, if the new indicator is better than the indicator (or selected range), then the terms of the financial instrument are favorably modified. If, however, the new indicator is worse than the indicator (or selected range), then the terms of the financial instrument are adversely modified. If the new indicator and the indicator are equal, or within the selected range, there is no change to the terms.

Further, the preferred embodiment is a method for achieving target terms of a financial instrument by selecting a proposed target indicator and/or achieving a target indicator by selecting desired target financial-instrument terms, entering company resources and computing actions to achieve the desired target terms or the proposed target indicator through use of company resources. The actions could comprise political actions, economic actions, social actions, technological actions, legal actions, environmental actions, charitable actions, policy actions, regulatory actions, financial actions, and/or combinations thereof.

Additionally the preferred embodiment is a method for utilizing the indicator for determining terms of a financial instrument. The indicator could comprise scores, ratings and/or indexes, which in turn could comprise letters, numbers and/or individual distinguishable characters. Further, the indicator is based on industry data, location data, organization data and/or is representative of at least one PESTLE variable.

The indicator selectively modifies, revises and/or retains at least one term of the financial instrument. Terms may include, for exemplary purposes only, interest rates, calling terms, redemption terms, conversion terms, maturity, penalties, refunds and/or escrow terms. Financial instruments comprise, for exemplary purposes only, debt instruments, contractual assurances to repay in the form of a promissory note, a credit facility, a bill of exchange, a bond, a debenture, a loan, a note and/or an instrument of indebtedness.

Further, the preferred embodiment is a method for determining terms of a financial instrument based on an indicator, wherein a request for indebtedness from a borrower is processed. The indicator is then processed and calculated from PESTLE data, data from questions posed to an online community, and/or third party data. A time expiration is assigned to the financial instrument and adjusts the terms of the financial instrument based on the indicator.

Additionally, the preferred embodiment is a method of calculating an indicator based on PESTLE variables from responses to surveys, questionnaires, pick lists, votes, opinion polls and/or individual opinions. The indicator determines at least one term of the financial instrument by obtaining organization data and sentiment data, wherein the organization data and the sentiment data comprises PESTLE data, and weighting the organization and sentiment data via a voting community.

The preferred embodiment is also a method of utilizing an indicator to modify at least one term of a financial instrument, wherein data is obtained from a computer-generated survey and weighed by weighting factors to obtain the indicator. The indicator is then utilized to modify terms of the financial instrument, wherein the terms of the financial instrument include, for example, an issue date, an effective date and/or an expiration date. Additionally, the terms of the financial instrument may be modified based on a PESTLE indicator and/or a future indicator via a computer. The PESTLE indicator and the future indicator are determined at a future date, and may change in numerical value during the life of the financial instrument.

The preferred embodiment is also a method for utilizing an indicator for a financial instrument, wherein the indicator triggers modification of at least one term of the financial instrument. Sentiment data comprising at least one PESTLE variable representative of an organization is obtained via a computer. The sentiment data is weighted by a voting community to obtain a baseline indicator. The baseline indicator is compared to a future indicator based on at least one PESTLE variable, wherein an output is determined comprising incremental valuation changes and/or triggering events. The triggering events modify predefined terms of the financial instrument.

Additionally, the preferred embodiment is a method of utilizing an indicator to modify a financial instrument by obtaining at least one PESTLE variable from a third party. Sentiment data is processed and the PESTLE variable(s) are chosen by a voting community. A weighting process is attached to the PESTLE variable(s), wherein an indicator is calculated. The PESTLE variable(s) are also utilized to calculate a future indicator, wherein the indicator and future indicator are subsequently compared and utilized to modify a term of the financial instrument.

Further, the preferred embodiment is a method of constructing a financial instrument by generating an indicator for an organization based on PESTLE factors. A time expiration is then determined and the indicator is reevaluated during and up to the time expiration. At the time expiration an updated indicator is generated based on the performance of an organization and is the basis for at least one term of the financial instrument, wherein the performance of the organization numerically changes based on action or inaction of the organization.

Additionally, the preferred embodiment is a method of determining settlement terms of a financial instrument. A baseline indicator is generated for an organization. A time expiration is determined for the financial instrument and a target indicator for the organization to achieve by the time expiration is determined. The indicator is then reevaluated at scheduled intervals, wherein incremental value attaches to the indicator at the scheduled intervals.

The preferred embodiment is a method for creating a baseline for a financial instrument via a computer network by obtaining and weighting sentiment data. The sentiment data is obtained from voting and polling an online community. The financial instrument comprises a bond, a note, a debenture, a credit facility, a loan, a barter, a fund and/or a transfer of capital with the expectation of return.

Additionally, the preferred embodiment is a method of determining at least one term of a financial instrument by processing an indicator, wherein the indicator determines terms of a financial instrument. The indicator is representative of PESTLE data and at least one organization, such as, non-profit organizations, profit organizations, governments, government agencies, subsidiaries, businesses and/or associations. The financial instrument comprises a financial fixed-income security, a financial debt instrument, a financial credit instrument, a municipal debt instrument, a corporate debt instrument and/or a sovereign debt instrument, such as a municipal bond.

Lastly, the preferred embodiment is a method of determining the terms of a financial instrument by computing an indicator. The indicator is computed from responses from an on-line community and transforming the responses to form the indicator.

More specifically, the preferred embodiment is a method for modifying the terms of a financial instrument by computing an initial indicator and improving the indicator based on changes to organization data over time. The organization data is stored in a database on a server which is in electrical communication with the server. Organizations comprise, for exemplary purposes only, corporations, governments, non-profit organizations, for-profit organizations, and/or the like, that wish to issue a financial instrument, such as, for exemplary purposes only, bonds. The organization data related to the organizations comprises, for exemplary purposes only, information from independent parties, organizations, indexes and data representing indexes. Independent parties comprise, for exemplary purposes only, a party and/or individual dissociated from a particular organization. Indexes comprise financial indexes, such as, for exemplary purposes only, the Dow Jones Industrial Average, the S&P 500 Composite Stock Price Index, and the like. Data representing indexes comprises, for exemplary purposes only, information, studies, derivatives and/or evaluations of financial indexes.

Subsequently, the organization data is selectively categorized into a first group, a second group, a first division, a second division, a first region and a second region. Groups comprise, for exemplary purposes only, a plurality of individual organizations. Divisions comprise particular combinations of the organizations, such as, for exemplary purposes only, into sectors of goods and/or service industries, or on a finer scale for large organizations, into the manufacturing sector or service sector of the organization. Regions comprise combinations of organizations doing business in a geographical location, such as, for exemplary purposes only, entities doing business in the State of California. It will be recognized by those skilled in the art that more than two groups and/or more than two divisions and/or more than two regions could be utilized.

Organization data is subsequently selected from, for exemplary purposes only, political data, economic data, social data, technological data, legal data, environmental data, charitable data, policy data, regulatory data and/or financial data, which generally relate to the PESTLE factors. It will be recognized by those skilled in the art that other sources of organization data or fewer/additional sources of organization data could selectively be utilized.

Subsequently, weighting factors corresponding to respective organization data are quantified and selected, wherein the weighting factors comprise, for exemplary purposes only, data from perception polls, surveys, questionnaires, pick lists, votes, opinion polls and/or individual opinions. It will be recognized by those skilled in the art that other sources of data or fewer/additional sources of data could selectively be utilized.

The organization data is weighted by the weighting factors, thereby resulting in an indicator. The indicator is then stored in the database on the server and may then be selectively accessed from the server or the Internet via the computer. The indicator comprises a benchmark for total and unified sustainability of an organization. The indicator further comprises indicators of progress toward objectives, namely, climate balance, restoring the Earth and uplifting humanity and is designed to incentivize support of the objectives so that achievement of the objectives results in increased global happiness on a massive scale.

When it is desired to create or modify the terms of a financial instrument, the indicator is selectively accessed from the server or the Internet to create or modify the terms of the financial instrument. The terms typically may comprise, for exemplary purposes only, market value, price, interest rate, settlement value, rating, and/or the like. The financial instrument could comprise, for exemplary purposes only, stocks, bonds, commercial paper, debentures, certificates, and/or the like. A modified financial instrument or derivative of the financial instrument could subsequently be traded on, for exemplary purposes only, an exchange system or the like.

After a finite period of time has elapsed, new organization data is gathered. The new organization data is stored in the database on the server. The new organization data is obtained from independent parties, organizations, indexes and data representing indexes, wherein the information from the independent parties, the organizations, the indexes and the data representing indexes were previously utilized in obtaining the indicator as discussed hereinabove. The new organization data comprises for exemplary purposes only, financial information, debt information, profit information and/or the like, from organizations, such as, for exemplary purposes only, corporations, governments and/or non-profit organizations.

Subsequently, the new organization data is categorized into a first group, a second group, a first division, a second division, a first region and a second region, wherein the groups, the divisions and the regions were previously utilized in obtaining the indicator as discussed hereinabove.

The new organization data is subsequently selected from PESTLE-related variable, such as, for exemplary purposes only, new political data, new economic data, new social data, new technological data, new legal data, new environmental data, new charitable data, new policy data, new regulatory data and/or new financial data. It will be recognized by those skilled in the art that other sources of data or fewer/additional sources of data could selectively be utilized.

Subsequently, new weighting factors, corresponding to respective new organization data, are chosen and quantified. The new weighting factors comprise, for exemplary purposes only, perception polls, surveys, questionnaires, pick lists, votes, opinion polls and individual opinions. It will be recognized by those skilled in the art that other sources of data or fewer/additional sources of data could selectively be utilized.

The new organization data is subsequently weighted by the new weighting factors, resulting in a new indicator. The new indicator is selectively stored in the database on the server, wherein the new indicator is accessed from the server or the Internet via the computer.

When it is desired to modify the terms of a financial instrument or to project actions that should result in more favorable terms, the new indicator and the indicator are obtained from the server or the Internet. The new indicator and the indicator are compared, and if the new indicator is better than the indicator (or selected range for the indicator), then the terms of the financial instrument are selectively modified into new terms that are more favorable than the original terms. If the new indicator is worse than the indicator (or selected range for the indicator), then the terms of the financial instrument are selectively modified into new terms that are less favorable then the original terms. If the new indicator is not greater than or less than the indicator or selected range, then no modification of the terms of the financial instrument occurs.

When an organization desires to improve its financial instrument terms, it may compute the actions necessary to achieve an improved new indicator that results in improved new terms. Alternately, the organization may select certain terms that it wishes to improve in its financial instrument and determines the new indicator that would be required for such improved new terms. In order to achieve the new indicator, the organization also determines actions, based on its available resources, that results in the improved new indicator. Accordingly, the indicator is obtained from the server or the Internet and the terms of the financial instrument are also obtained. A target indicator and/or target terms is/are entered into the computer, along with company resources. The computer computes proposed actions to achieve the target indicator and/or the target terms based on the company resources. The proposed actions may comprise political actions, economic actions, social actions, technological actions, legal actions, environmental actions, charitable actions, policy actions, regulatory actions and/or financial actions. It will be recognized by those skilled in the art that other actions, or additional/fewer actions, by organizations could be proposed.

Subsequently, an organization implements the proposed actions, and if the proposed actions are achieved, the organization indicates such to the holder of its financial instrument requesting revision of the terms to the new terms. If the proposed actions are not achieved by the organization, then no change of the terms occurs.

Accordingly, a feature and advantage of the preferred embodiment is its ability to improve the value of the natural Earth, uplift humanity and promote climate balance.

Another feature and advantage of the preferred embodiment is its ability to evaluate organizations beyond financial measures by taking into account PESTLE variables.

Still another feature and advantage of the preferred embodiment is its ability to evaluate consensus data.

Yet another feature and advantage of the preferred embodiment is that it encourages socially responsible practices.

A further feature and advantage of the preferred embodiment is its ability to align financial instruments with shareholder, societal and environmental data.

A further feature and advantage of the preferred embodiment is its ability to incentivize or penalize the actions of organizations.

Still another feature and advantage of the preferred embodiment is its ability to provide a universal indicator for financial instruments.

Another feature and advantage of the preferred embodiment is its ability to utilize a computer-generated indicator to understand how organizations support climate balance, uplifting humanity and improving the value of Earth.

These and other features and advantages of the preferred embodiment will become more apparent to one skilled in the art from the following description and claims when read in light of the accompanying drawings.

### BRIEF DESCRIPTION OF THE SEVERAL VIEWS OF THE DRAWINGS

The preferred embodiment will be better understood by reading the Detailed Description of the Preferred and Selected Alternate Embodiments with reference to the accompanying drawing figures, in which like reference numerals denote similar structure and refer to like elements throughout, and in which:

FIG. 1 is a flowchart illustrating a method for modifying the terms of a financial instrument from a computer-processed score, according to a preferred embodiment;

FIG. 2 is a detail flowchart depicting gathering of organization data according to a preferred embodiment of a method for modifying the terms of a financial instrument;

FIG. 3 is a detail flowchart of categorizing organization data according to a preferred embodiment of a method for modifying the terms of a financial instrument;

FIG. 4 is a detail flowchart of selecting organization data according to a preferred embodiment of a method score for a financial instrument;

FIG. 5 is a detail flowchart of quantifying and selecting weighting factors according to a preferred embodiment of a method for modifying the terms of a financial instrument;

FIG. 6 illustrates the components of a score utilized as a benchmark for total and unified sustainability of organizations according to a preferred embodiment of a method for modifying the terms of a financial instrument;

FIG. 7 illustrates the components of a server utilized according to a preferred embodiment of a method for modifying the terms of a financial instrument;

FIG. 8 is a flowchart illustrating a method for generating a new score according to the preferred embodiment of a method for modifying the terms of a financial instrument;

FIG. 9 illustrates the components of a server utilized according to a preferred embodiment of a method for modifying the terms of a financial instrument;

FIG. 10 is a detail flowchart of selecting new organization data according to a preferred embodiment of a method for modifying the terms of a financial instrument;

FIG. 11 is a flowchart illustrating a method for comparing a score and a new score and modifying a financial instrument according to the preferred embodiment of a method for modifying the terms of a financial instrument;

FIG. 12 is a flowchart illustrating a method for computing actions to reach a target according to an alternate embodiment of a method for modifying the terms of a financial instrument;

FIG. 13 is a detail flowchart of computing actions according to an alternate embodiment of a method for modifying the terms of a financial instrument;

FIG. 14 illustrates the components of a server utilized according to an alternate embodiment of a method for modifying the terms of a financial instrument;

FIG. 15 is a flowchart illustrating revision of terms of a financial instrument based on an organization's actions according to an alternate embodiment of a method for modifying the terms of a financial instrument;

FIG. 16 illustrates types of terms for a financial instrument according to the preferred embodiment of a method for modifying the terms of a financial instrument;

FIG. 17 illustrates types of a financial instrument according to the preferred embodiment of a method for modifying the terms of a financial instrument;

FIG. 18 is a flowchart illustrating a method for obtaining and weighting a PESTLE variable and modifying the terms of a financial instrument according to the preferred embodiment of a method for modifying the terms of a financial instrument;

FIG. 19 is a flowchart illustrating a method for generating a new score at a time expiration according to the preferred embodiment of a method for modifying the terms of a financial instrument; and

FIG. 20 is a flowchart illustrating a method for generating a baseline score and modifying the baseline score at a time expiration according to the preferred embodiment of a method for modifying the terms of a financial instrument.

### DETAILED DESCRIPTION OF THE PREFERRED AND SELECTED ALTERNATE EMBODIMENTS OF THE INVENTION

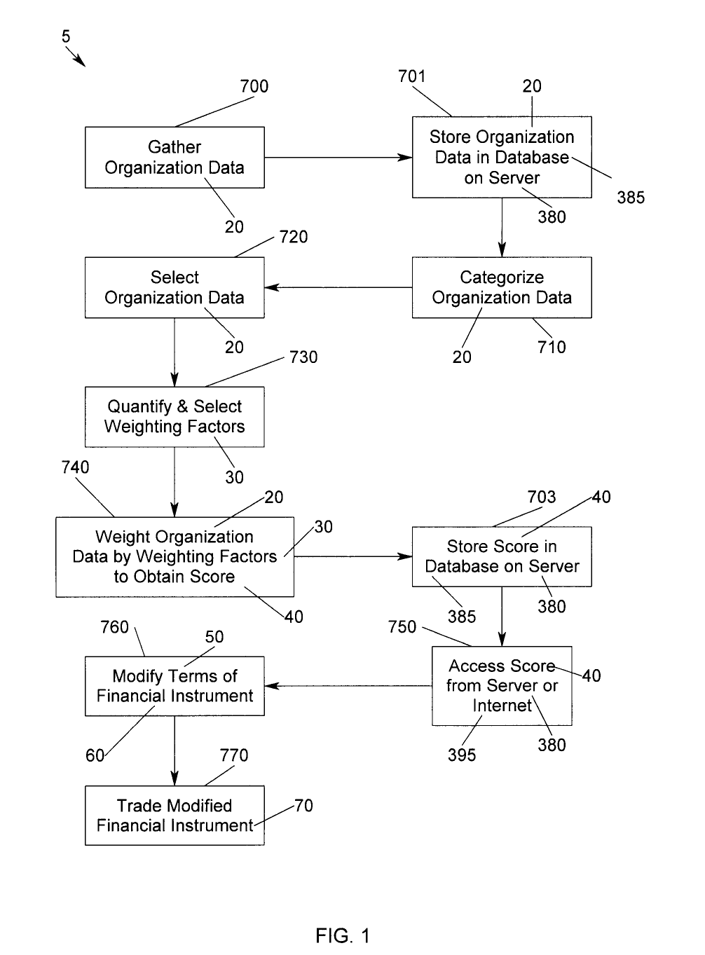

In describing the preferred and selected alternate embodiments, as illustrated in FIGS. 1-20, specific terminology is employed for the sake of clarity. The preferred embodiment, however, is not intended to be limited to the specific terminology so selected, and it is to be understood that each specific element includes all technical equivalents that operate in a similar manner to accomplish similar functions.

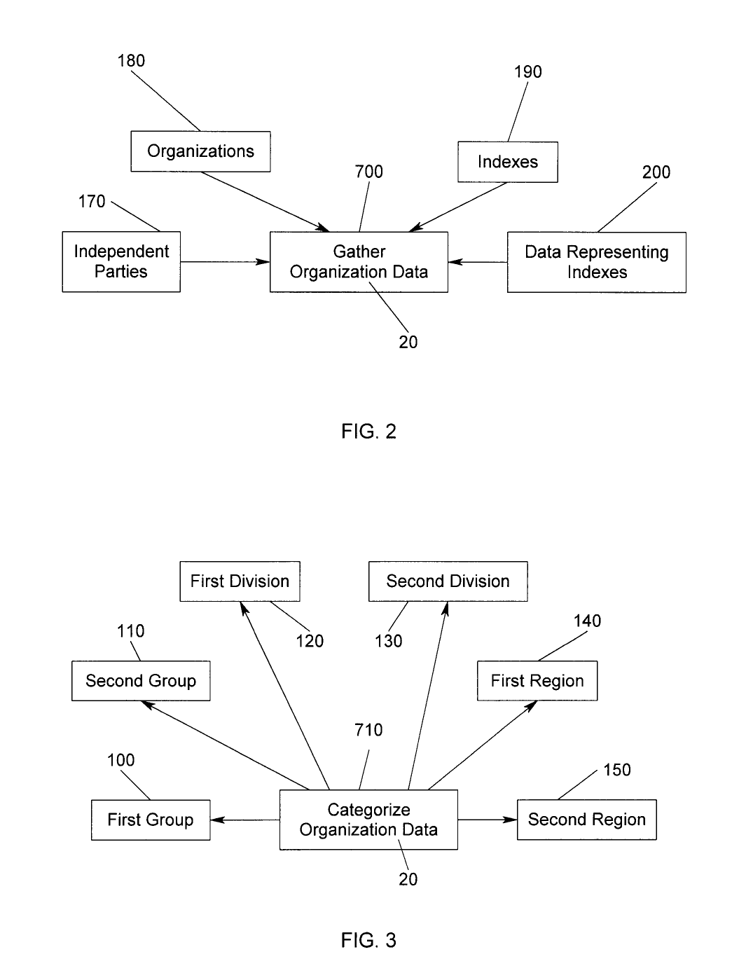

Referring now to FIGS. 1-7, method for modifying the terms of a financial instrument 5 comprises organization data 20, wherein organization data 20 is gathered via step 700, and wherein organization data 20 is stored in database 385 on server 380 (best shown in FIG. 7) via step 701, and wherein computer 390 is in electrical communication with server 380. As best shown in FIG. 2, organization data 20 comprises, for exemplary purposes only, information from independent parties 170, organizations 180, indexes 190 and data representing indexes 200. Independent parties 170 comprise, for exemplary purposes only, a party and/or individual dissociated from a particular organization 180. Organizations 180 comprise, for exemplary purposes only, corporations 310, governments 320, non-profit organizations 330, for-profit organizations 340, and/or the like, that wish to issue financial instruments 60, such as, for exemplary purposes only, bonds. Indexes 190 comprise financial indexes, such as, for exemplary purposes only, the Dow Jones Industrial Average, the S&P 500 Composite Stock Price Index, and the like. Data representing indexes 200 comprises, for exemplary purposes only, information, studies and/or evaluations of financial indexes.

Subsequent to storing organization data 20 via step 701, organization data 20 is categorized via step 710, wherein organization data 20 is categorized into first group 100, second group 110, first division 120, second division 130, first region 140 and second region 150 (best shown in detail in FIG. 3). Groups 100, 110 comprise, for exemplary purposes only, a plurality of individual organizations 180. Divisions 120, 130 comprise particular combinations of organizations 180 in sectors of goods and/or service industries, such as, for exemplary purposes only, manufacturing sector or service sector, or more with more detail, automobile manufacturing, fast food service, and the like. Regions 140, 150 comprise combinations of organizations in a geographical location, such as, for exemplary purposes only, entities doing business in the State of California. It will be recognized by those skilled in the art that more than two groups 100, 110 and/or more than two divisions 120, 130 and/or more than two regions 140, 150 could be utilized.

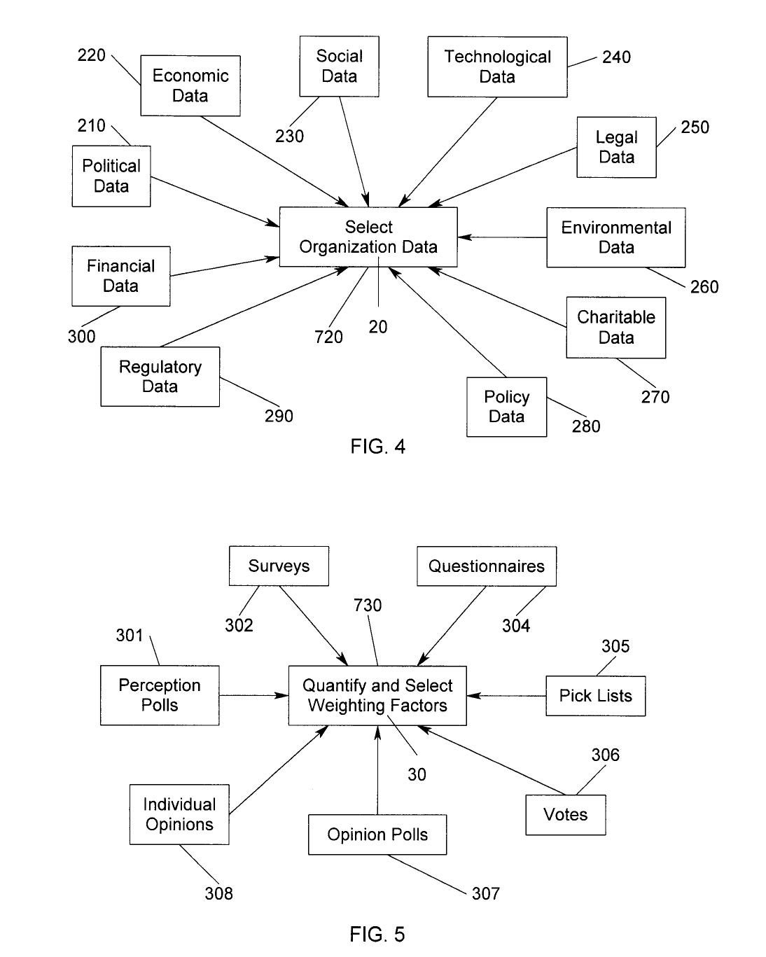

Returning again to FIG. 1, organization data 20 is subsequently selected via step 720, wherein organization data 20 is selected from, for exemplary purposes only, political data 210, economic data 220, social data 230, technological data 240, legal data 250, environmental data 260, charitable data 270, policy data 280, regulatory data 290 and financial data 300 (best shown in detail in FIG. 4), and wherein political data 200, economic data 220, social data 230, technological data 240, legal data 250, environmental data 260, charitable data 270, policy data 280, regulatory data 290 and/or financial data 300 may commonly be referred to as P.E.S.T.L.E. (political, economic, social, technological, legal and environmental) data and/or factors and/or commonly referred to as “variables.” It will be recognized by those skilled in the art that other sources of organization data 180 or fewer/additional sources of organization data 180 could selectively be utilized.

Subsequently, weighting factors 30 corresponding to respective organization data 20 are quantified and selected via step 730, wherein weighting factors 30 comprise, for exemplary purposes only, data from perception polls 301, surveys 302, questionnaires 304, pick lists 305, votes 306, opinion polls 307 and individual opinions 308 (best shown in detail in FIG. 5) It will be recognized by those skilled in the art that other sources of data or fewer/additional sources of data could selectively be utilized.

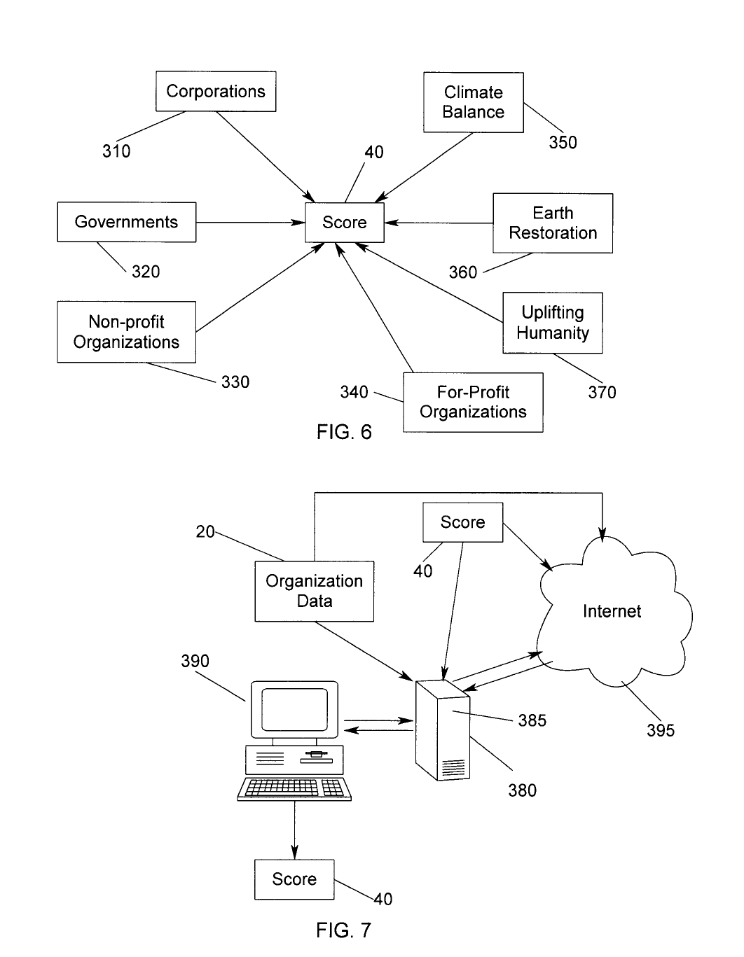

Still referring to FIG. 1, organization data 20 is weighted via step 740 by weighting factors 30 resulting in score 40, wherein score 40 is stored in database 385 on server 380 via step 703 (best shown in FIG. 7), and wherein score 40 is selectively accessed from server 380 or Internet 395 via computer 390. As shown in FIG. 6, score 40 comprises a benchmark for total and unified sustainability of an entity organization, such as, for exemplary purposes only, corporations 310, governments 320, non-profit organizations 330 and for-profit organizations 340. Score 40 further comprises indicators of progress toward objectives, namely, climate balance 350, restoring the Earth 360 and uplifting humanity 370, wherein score 40 is designed to incentivize support of objectives 350, 360, 370, and wherein achievement of objectives 350, 360, 370 results in increased global happiness on a massive scale.

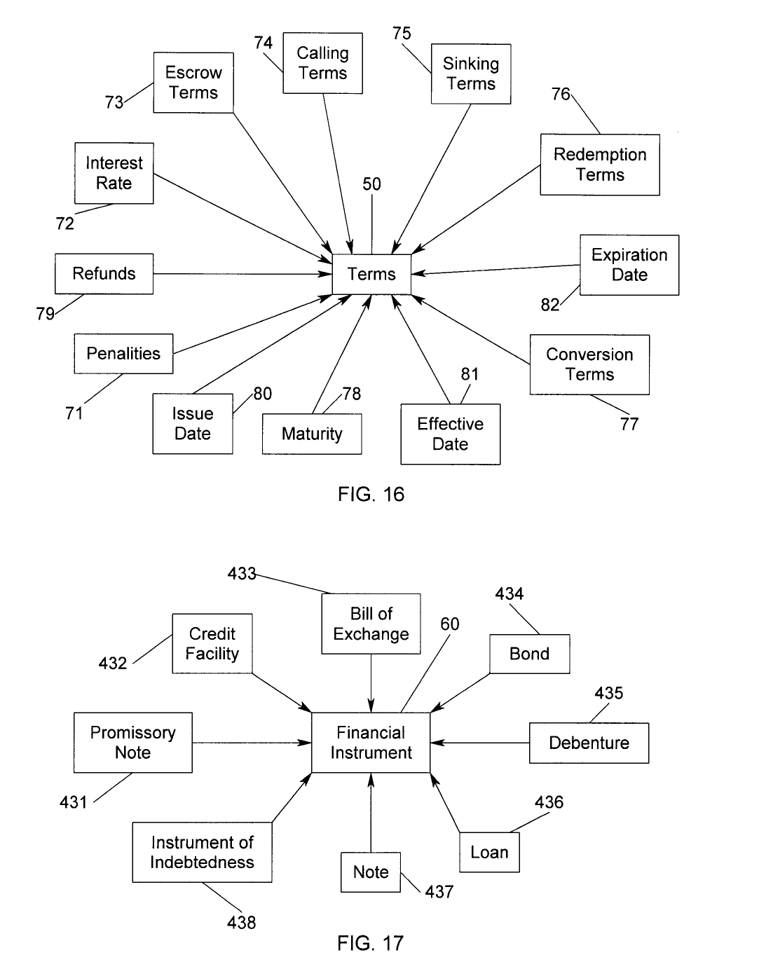

Referring to FIGS. 1, 16 and 17, score 40 is accessed from server 380 or Internet 395 via step 750, wherein score 40 is utilized to initially create and/or obtain and/or subsequently modify terms 50 of financial instrument 60 via step 760. As shown in FIG. 16, terms 50 could comprise, for exemplary purposes only, penalties 71, interest rate 72, escrow terms 73, calling terms 74, sinking terms 75, redemption terms 76, conversion terms 77, maturity 78, refunds 79, issue date 80, effective date 81, expiration date 82, and/or the like. As shown in FIG. 17, financial instrument 60 could comprise, for exemplary purposes only, promissory note 431, credit facility 432, bill of exchange 433, bond 434, debenture 435, loan 436, note 437, instrument of indebtedness 438, and/or the like. Modified financial instrument 70 could subsequently be traded via step 770 on, for exemplary purposes only, an exchange system or the like.

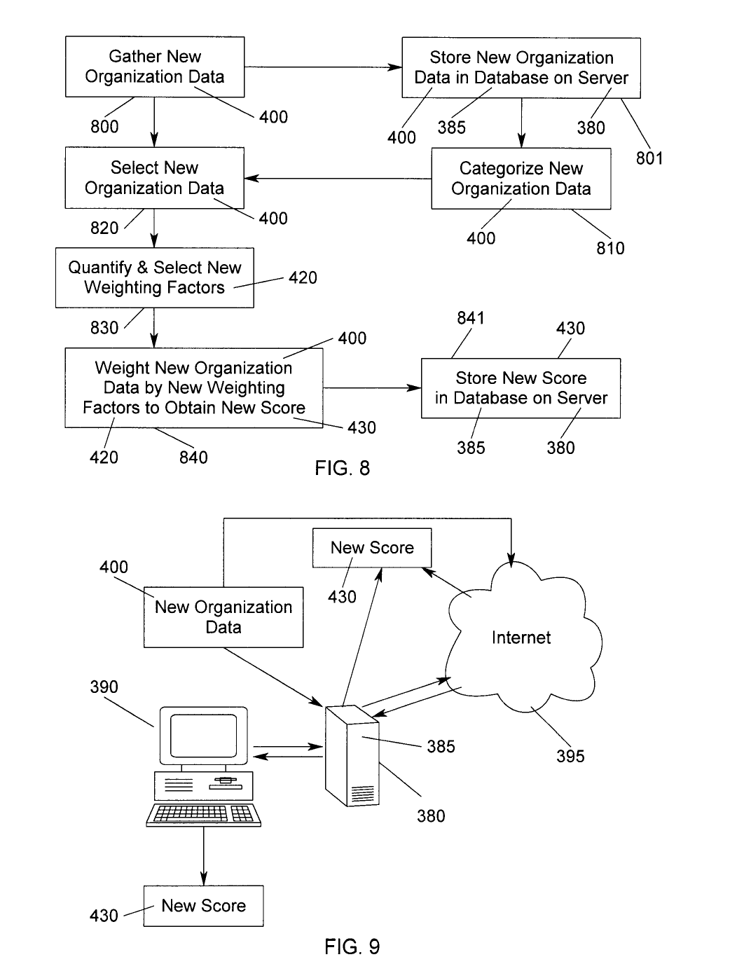

Referring now to FIGS. 8-10, after a finite period of time has elapsed, new organization data 400 is gathered via step 800, wherein new organization data 400 is stored via step 801 in database 385 on server 380 (as best shown in FIG. 9). New organization data 400 is obtained from independent parties 170, organizations 180, indexes 190 and data representing indexes 200 (best shown in FIG. 2), wherein information from independent parties 170, organizations 180, indexes 190 and data representing indexes 200 were previously utilized in obtaining score 40 as discussed hereinabove, and wherein new organization data 400 comprises for exemplary purposes only, financial information, debt information, profit information and/or the like, from organizations, such as, for exemplary purposes only, corporations 310, governments 320 and/or non-profit organizations 330.

Subsequently, new organization data 400 is categorized via step 810 into first group 100, second group 110, first division 120, second division 130, first region 140 and second region 150, wherein groups 100, 110, divisions 120, 130 and regions 140, 150 were previously utilized in obtaining score 40 as discussed hereinabove.

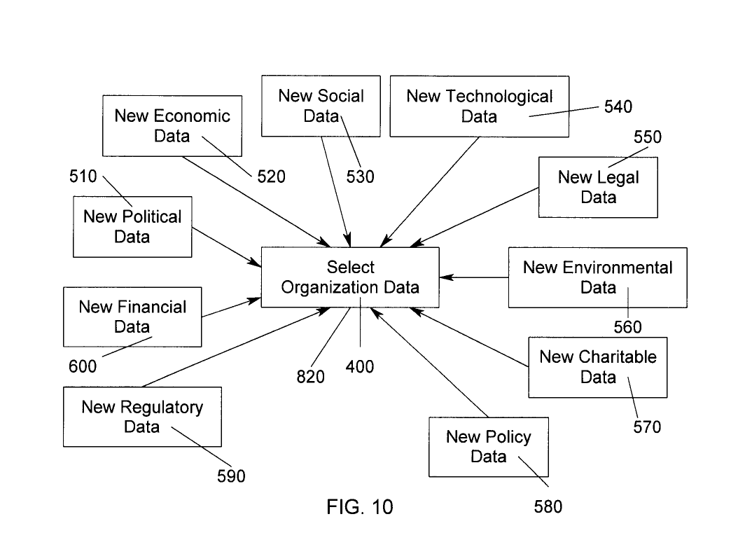

New organization data 400 is subsequently selected via step 820, wherein new organization data 400 is selected from new political data 510, new economic data 520, new social data 530, new technological data 540, new legal data 550, new environmental data 560, new charitable data 570, new policy data 580, new regulatory data 590 and new financial data 600 (best shown in FIG. 10) It will be recognized by those skilled in the art that other sources of data or fewer/additional sources of data could selectively be utilized.

Subsequently, new weighting factors 420, corresponding to respective new organization data 400, are quantified via step 830, wherein weighting factors 420 (as best shown in FIG. 5) comprise, for exemplary purposes only, perception polls 301, surveys 302, questionnaires 304, pick lists 305, votes 306, opinion polls 307 and individual opinions 308. It will be recognized by those skilled in the art that other sources of data or fewer/additional sources of data could selectively be utilized.

New organization data 400 is subsequently weighted via step 840 by new weighting factors 420, resulting in new score 430, wherein new score 430 is stored in database 385 on server 380 via step 841 (best shown in FIG. 9), and wherein new score 430 is accessed from server 380 or Internet 395 via computer 390 (best shown in FIG. 9).

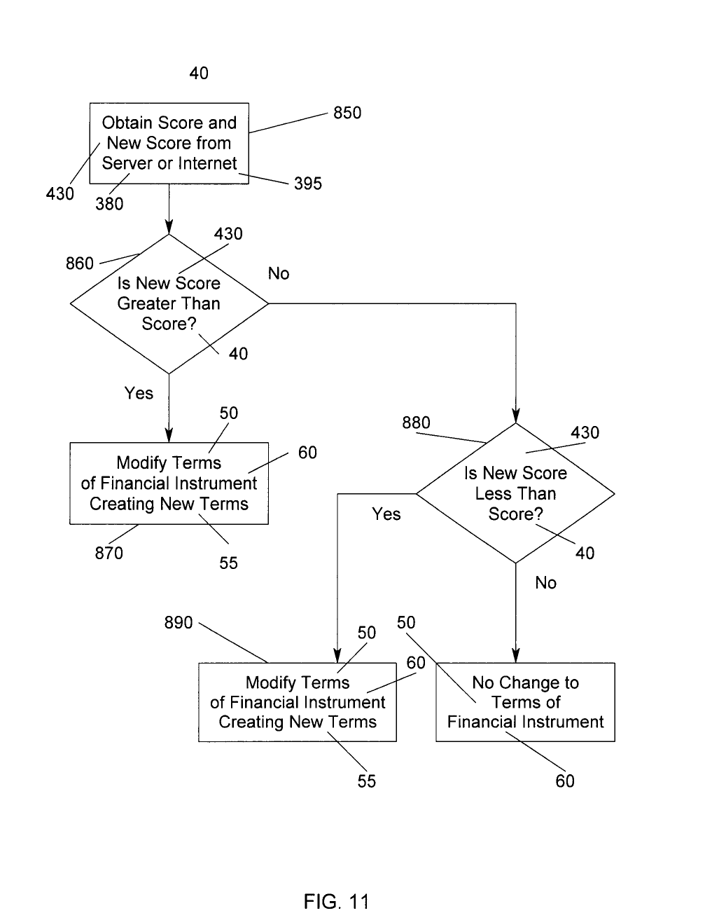

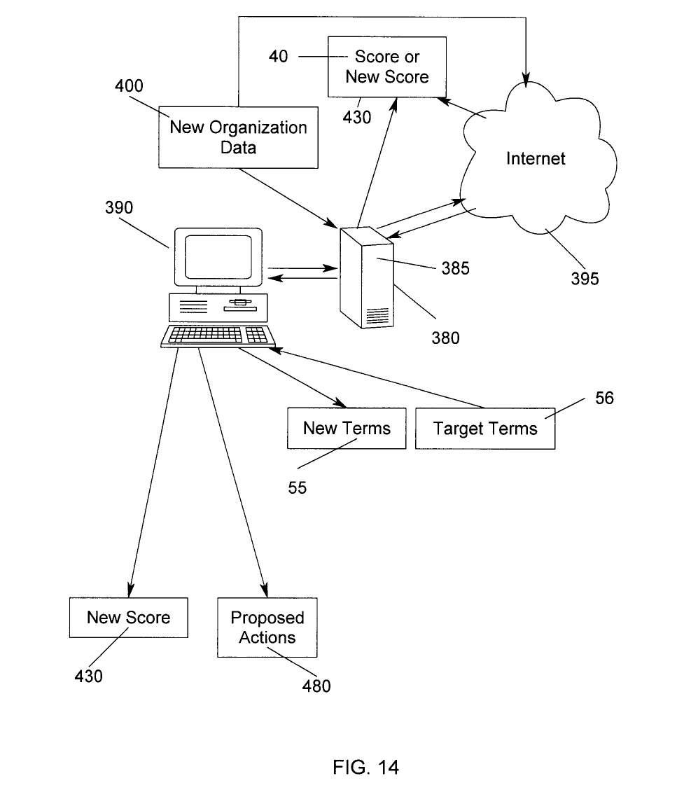

Referring now to FIG. 11, new score 430 and score 40 are obtained from server 380 or Internet 395 via step 850 (best shown in FIG. 14). New score 430 and score 40 are subsequently compared via step 860, wherein if new score 430 is greater than score 40, then terms 50 of financial instrument 60 are selectively modified via step 870 into new terms 55, wherein new terms 55 are more favorable then terms 50. If new score 430 is less than score 40, then new score 430 and score 40 are compared via step 880, wherein if new score 430 is less than score 40, then terms 50 of financial instrument 60 are selectively modified via step 890 into new terms 55, wherein new terms 55 are less favorable then terms 50. If new score 430 is not less than score 40 as computed in step 880, then new score 430 and score 40 are equal and no modification of terms 50 of financial instrument 60 occurs.

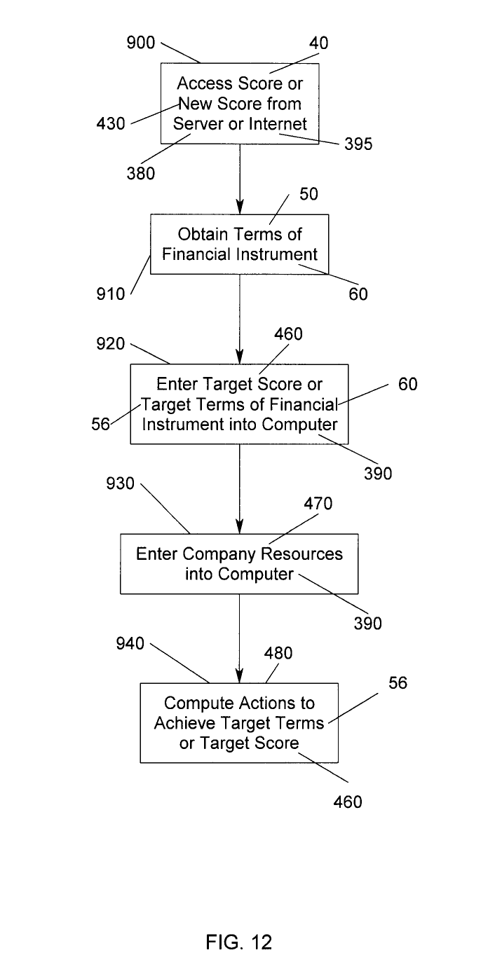

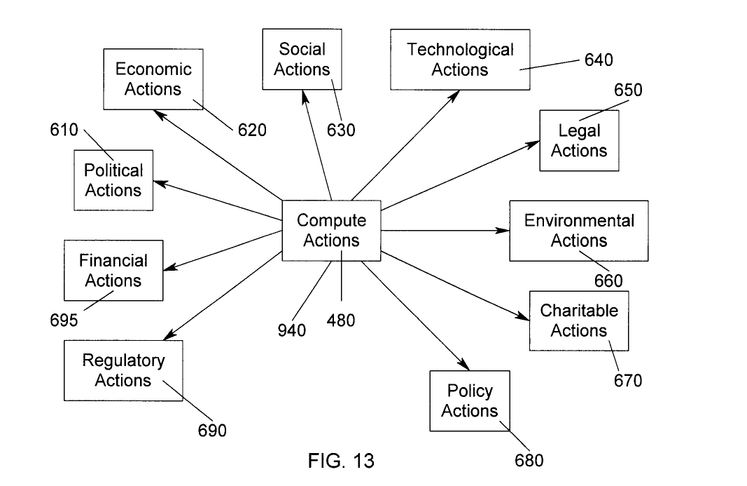

Referring now more specifically to FIGS. 12-15, illustrated therein is an alternate embodiment of modifying the terms of a financial instrument 5, wherein the alternate embodiment of FIGS. 12-15 is substantially equivalent in form and function to that of the preferred embodiment detailed and illustrated in FIGS. 1-11 except as hereinafter specifically referenced. Specifically, in the embodiment of FIGS. 12-15, new score 430 or score 40 is obtained from server 380 or Internet 395 via step 900 (best shown in FIG. 14). Subsequently, terms 50 of financial instrument 60 are obtained via step 910. Target score 460 and/or target terms 56 of financial instrument 60 are/is entered into computer 390 via step 920. Company resources 470 are entered into computer 390 via step 930, wherein computer 390 computes via step 940 proposed actions 480 to achieve target score 460 and/or target terms 56 based on company resources 470. As best shown in FIG. 13, proposed actions 480 comprise political actions 610, economic actions 620, social actions 630, technological actions 640, legal actions 650, environmental actions 660, charitable actions 670, policy actions 680, regulatory actions 690 and/or financial actions 695. It will be recognized by those skilled in the art that other actions, or additional/fewer actions, by organizations could be proposed.

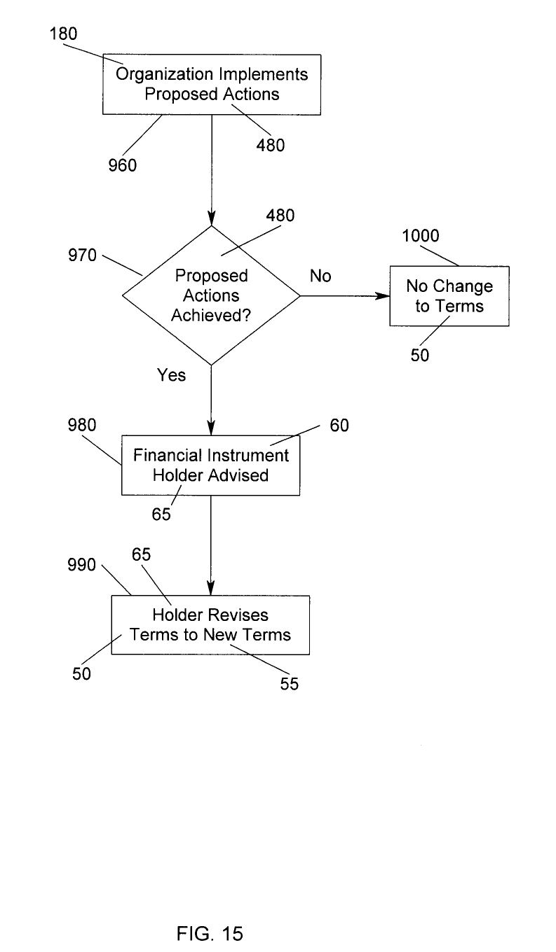

Turning now to FIG. 15, organization 180 implements proposed actions 480 via step 960 and, if proposed actions 480 are achieved in step 970, organization 180 indicates same to holder 65 of financial instrument 60 via step 980, wherein holder 65 of financial instrument 60, revises terms 50 via step 990 to reflect new terms 55. If proposed actions 480 are not achieved via step 970, no change to terms 50 occurs.

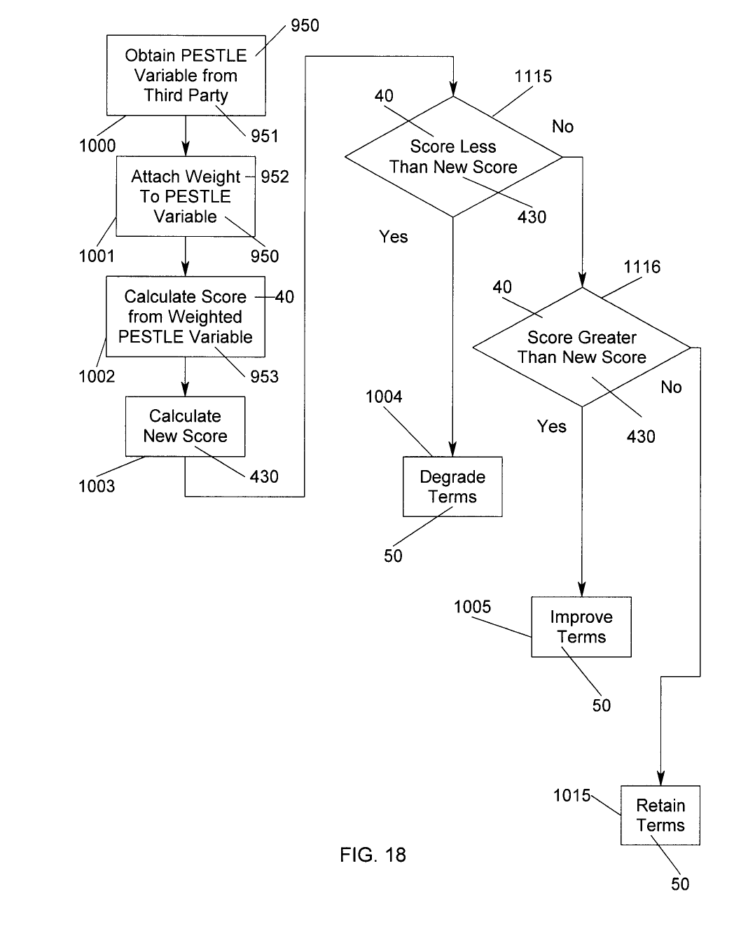

Referring now to FIG. 18, PESTLE variable 950 is obtained from third party 951 via step 1000, wherein weight 952 is attached to PESTLE variable 950 via step 1001. Score 40 is subsequently calculated from weighted PESTLE variable 953 via step 1002, wherein new score 430 is calculated via step 1003. Score 40 and new score 430 is compared via step 1115, wherein if score 40 is less than new score 430, then terms 50 are degraded via step 1004. Alternatively, score 40 is compared to new score 430 via step 116, wherein if score 40 is greater than new score 430, then terms 50 are improved via step 1005, and if score 40 is not greater than new score 430, then terms 50 are retained unchanged via step 1015.

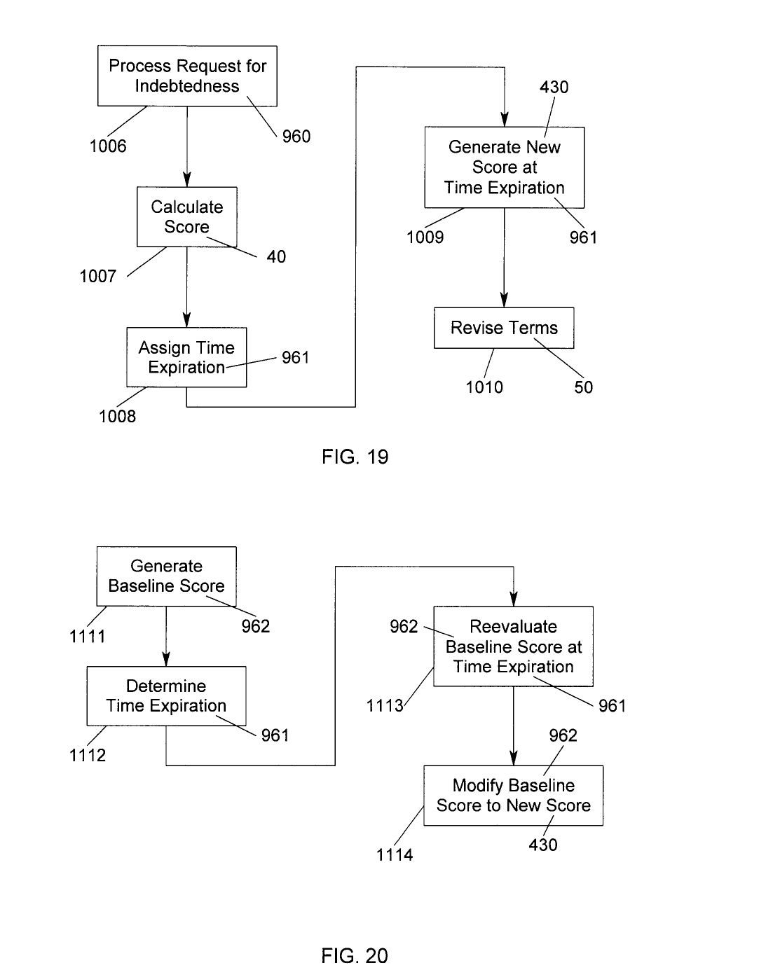

Referring now to FIG. 19, request for indebtedness 960 is processed via step 1006, wherein score 40 is calculated via step 1007. Subsequently, time expiration 961 is assigned via step 1008, wherein new score 430 is generated at time expiration 961 via step 1009, and wherein terms 50 are revised via step 1010.

Turning now to FIG. 20, baseline score 962 is generated via step 1111, wherein time expiration 961 is determined via step 1112. Subsequently, baseline score 962 is reevaluated at time expiration 961 via step 1113, wherein baseline score 962 is modified to new score 430 via step 1114.

By way of example and without limitation, Table I hereinbelow illustrates the preferred embodiment, wherein four variables, education, water stewardship, recycling and volunteerism are selected for improvement, and wherein each of these four areas is assigned a weight of 25%, and wherein the weight is fixed for the term of a financial instrument.

TABLE I

| Company | | * Adjustment Modified | | | |
|---|---|---|---|---|---|
| XYZ | Industry | Interest Rate | | | Score |
| Score | Score | (score | rate | target date) | Revaluation |
| 880 | 890 | ≧890 | 5% | Mar. 31, 2010 | Monthly |
| | | <890 > 880 | 7% | Mar. 31, 2010 | |
| | | <880 | 9% | Mar. 31, 2010 | |

Company XYZ has score 40 (including PESTLE factors) of 880, wherein the average score 40 of companies in the industry in which Company XYZ is 890. Because Company XYZ has score 40 that is less than the average score 40 of the industry in which it operates, Company XYZ will have to pay an interest rate that is higher than the interest rate of its competitors, so that its cost of capital is higher. Accordingly, Company XYZ would benefit from having score 40 that is at least equal to or greater than the average score 40 of its competitors.

Company XYZ could increase its score 40 by traditional methods, such as, for exemplary purpose only, increasing its cash flow, increasing its asset values, decreasing its liability value, and/or the like. Alternatively, Company XYZ could increase its score 40 by negotiating for financial instrument 60 having an interest rate that is modifiable based on achievement of selected PESTLE target variables, as negotiated between the parties as noted above.

In this Example, Company XYZ will get an interest rate of 5% if it achieves new score 430 equal to or greater than industry score 40 of 890, Company XYZ will get an interest rate of 7% if it maintains its new score 430 between 890 and 880, and Company XYZ will be required to pay an increased interest rate of 9% if its new score 430 drops below 880, all as measured as of a fixed date of Mar. 31, 2010.

If, Company XYZ initially has PESTLE factor variables included in score 40 comprising an education variable of 50, a water stewardship variable of 20, a recycling variable of 30 and a volunteerism variable of 50, wherein each variable is weighted by 25%, this results in a base PESTLE threshold rating of 37.5.

If, after implementing its improvement program, Company XYZ as of Mar. 31, 2010 has achieved an education variable of 100, a water stewardship variable of 10, a recycling variable of 35 and a volunteerism variable of 65, wherein each variable is still weighted by 25%, then Company XYZ will have an increased PESTLE rating of 52.5. Since Company XYZ has increased its PESTLE rating by 15, this is added to its score 40 of 880, resulting in a new score 430 of 895. Accordingly, on Mar. 31, 2010 Company XYZ will have its interest rate adjusted down to 5% until the next reevaluation date.

Additionally, it should be noted that PESTLE scoring is an analytical technique used for carrying out a pre-emptive check-up of an organization. The basic idea is to capture data of the organization that a voting community has determined relevant. The community chooses the PESTLE variables based on online surveys. Once the variables are selected, a processor computes a weighting of the variables as means to track a consistent measure of variance in the future in regard to the selected variables and the generated weights. By way of example as shown hereinbelow in Table II, if the community voted variable A,B,C and D are important and the processing assigned a 25% weight to each (if this reflects the results of the voting process), then we assess the organization.

For example, Organization 1, based on either third party data, the organizational contributed data, or voting data (or combination thereof) has scores as follows; variable A/volunteerism=7, variable B/recycling=5, variable C/community education=3, variable D/environmental policy=6. 7+5+3+6 equally weighted, if added equal a PESTLE score of 21. Now 21 is the organizational baseline, but what about other organizations in this sector, industry, geographic location? We can now compare all of them.

If we attached a loan interest rate to organization A's PESTLE score (again based on the same variables used in the baseline), organization A must achieve a score/indicator value of 24. Each year the score is revalued to determine organization A's score. Year 1, organization A has a score of 26 (increase of 2) Year 2, organization A has a score of 24 (no change) Year 3, organization A has a score of 22 (decrease of 2). Each year interest rate will be adjusted by way of example, as shown in Table II.

TABLE II
Organization A

| | |
|---|---|
| <17 | 9.75* |
| 18 | 8.75% |
| 19 | 8.50% |
| 20 | 8.25 |
| 21 | 8.00 |
| 22 | 7.75 |
| 23 | 7.50 |
| 24 | 7.25 |
| 25 | 7.00 |
| 26 | 6.75 |
| 27 | 6.50 |
| 28 | 6.25 |
| 29 | 6.00 |
| 30 | 5.75 |
| 31 | 5.50 |
| >32 | 4.50* |

*Incremental value is .25% per point (except <17 and >32)

Once the baseline has been established, it only represents a baseline for that financial instrument or relevant to that voted process, which means in the future the online community may vote other variables (they may weight differently) which means the financial instruments are subject to the online community. Although the financial instrument or any tradable instrument will be locked (that is the community can't change the weights or variables for a given instrument while it is alive), as time goes, the community will demand more in the form of corporate governance, environmental stewardships, etc. Which means the pressure is on for organizations to have high initial scores to achieve better terms on loans, notes, bonds, etc., without having to painfully make changes just to compete with the industry, region, etc.

The foregoing description and drawings comprise illustrative embodiments. Having thus described exemplary embodiments of the preferred and alternate embodiments, it should be noted by those skilled in the art that the within disclosures are exemplary only, and that various other alternatives, adaptations, and modifications may be made within the scope of the preferred embodiment. Merely listing or numbering the steps of a method in a certain order does not constitute any limitation on the order of the steps of that method. Many modifications and other embodiments will come to mind to one skilled in the art to which this preferred embodiment pertains having the benefit of the teachings presented in the foregoing descriptions and the associated drawings. Although specific terms may be employed herein, they are used in a generic and descriptive sense only and not for purposes of limitation. Accordingly, the preferred embodiment is not limited to the specific embodiments illustrated herein, but is limited only by the following claims.

1. A method for modifying the terms of a financial instrument, said method comprising the steps of:
obtaining organization data, wherein said organization data is selected from the group consisting of political data, social data, technological data, legal data, environmental data, charitable data, policy data, regulatory data, and combinations thereof;
obtaining weighting factors;
transforming said organization data by said weighting factors via a computer to obtain an indicator; and
relating said terms of said financial instrument to said indicator, wherein said terms are determined from said indicator.

2. The method of claim 1, wherein said step of obtaining said organization data comprises the step of:
obtaining said organization data from the group consisting of independent parties, organizations, indexes, data representing indexes, and combinations thereof.

3. The method of claim 2, wherein said step of obtaining said organization data further comprises the step of:
selecting said organization data from the group consisting of economic data, financial data, and combinations thereof.

4. The method of claim 3, wherein said step of obtaining said weighting factors comprises the step of:
selecting said weighting factors from the group consisting of responses to surveys, questionnaires, pick lists, votes, opinion polls, perception polls, individual opinions, and combinations thereof.

5. The method of claim 4, wherein said step of obtaining said weighting factors further comprises the step of:
quantifying said weighting factors.

6. The method of claim 1, wherein said step of obtaining said organization data further comprises the step of:
categorizing said organization data into groups.

7. The method of claim 1, wherein said step of obtaining said organization data further comprises the step of:
categorizing said organization data into divisions.

8. The method of claim 1, wherein said step of obtaining said organization data further comprises the step of:
categorizing said organization data into regions.

9. The method of claim 1, wherein said weighting factors are related to the type of said organization data being transformed.

10. The method of claim 1, said method further comprising the steps of:
obtaining at least one server, wherein said at least one server comprises at least one database;
storing said organization data into said at least one database; and
storing said indicator into said at least one database.

11. The method of claim 10, said method further comprising the step of:
connecting said server to transmit and receive data via the Internet.

12. The method of claim 1, wherein said step of obtaining said organization data further comprises the step of:
selecting said organization data from the group consisting of political data, economic data, social data, technological data, legal data, environmental data, charitable data, policy data, regulatory data, financial data, and combinations thereof.

13. The method of claim 1, wherein said step of obtaining said weighting factors comprises the step of:
selecting said weighting factors from the group consisting of responses to surveys, questionnaires, pick lists, votes, opinion polls, perception polls, individual opinions, and combinations thereof.

14. The method of claim 1, said method further comprises the steps of:
obtaining new organization data;
obtaining new weighting factors;
transforming said new organization data by said new weighting factors via said computer to obtain a new indicator; and
obtaining new terms for said financial instrument, wherein said new terms are determined by said new indicator.

15. The method of claim 14, wherein said step of obtaining said new organization data comprises the step of:
obtaining said new organization data from the group consisting of independent parties, organizations, indexes, data representing indexes, and combinations thereof.

16. The method of claim 15, wherein said step of obtaining said new organization data further comprises the step of:
selecting said new organization data from the group consisting of new political data, new economic data, new social data, new technological data, new legal data, new environmental data, new charitable data, new policy data, new regulatory data, new financial data, and combinations thereof.

17. The method of claim 16, wherein said step of obtaining said new weighting factors comprises the step of:
selecting said new weighting factors from the group consisting of responses to surveys, questionnaires, pick lists, votes, opinion polls, perception polls, individual opinions, and combinations thereof.

18. The method of claim 17, wherein said step of obtaining new weighting factors comprise the step of:
quantifying said new weighting factors.

19. The method of claim 14, wherein said step of obtaining said new organization data further comprises the step of:
selecting said new organization data from the group consisting of new political data, new economic data, new social data, new technological data, new legal data, new environmental data, new charitable data, new policy data, new regulatory data, new financial data, and combinations thereof.

20. The method of claim 14, wherein said step of obtaining said new weighting factors comprises the step of:
selecting said new weighting factors from the group consisting of responses to surveys, questionnaires, pick lists, votes, opinion polls, perception polls, individual opinions, and combinations thereof.

21. The method of claim 14, wherein said step of obtaining said new organization data further comprises the step of:
categorizing said new organization data into groups.

22. The method of claim 14, wherein said step of obtaining said new organization data further comprises the step of:
categorizing said new organization data into regions.

23. The method of claim 14, wherein said step of obtaining said new organization data further comprises the step of:
categorizing said new organization data into divisions.

24. The method of claim 14, wherein said method further comprises the steps of:
comparing said indicator to said new indicator; and
modifying said terms of said financial instrument if said new indicator is not within a selected range for said indicator.

25. The method of claim 24, said method further comprising the step of:
favorably modifying said terms of said financial instrument if said new indicator is better than said indicator.

26. The method of claim 24, said method further comprising the step of:
adversely modifying said terms of said financial instrument if said new indicator is worse than said indicator.

27. The method of claim 14, wherein said method further comprises the steps of:
obtaining at least one server, wherein said at least one server comprises at least one database;
storing said new organization data into said at least one database; and
storing said new indicator into said at least one database.

28. The method of claim 27, said method further comprising the step of:
connecting said server to transmit and receive data via the Internet.

29. The method of claim 1, wherein said method further comprises the steps of:
selecting a target indicator;
entering company resources; and
determining actions via said computer, wherein said actions are selected to achieve said target indicator.

30. The method of claim 29, wherein said actions are selected from the group consisting of political actions, economic actions, social actions, technological actions, legal actions, environmental actions, charitable actions, policy actions, regulatory actions, financial actions, and combinations thereof.

31. The method of claim 1, wherein said method further comprises the steps of:
selecting target terms;
entering company resources; and
determining actions via said computer, wherein said actions are selected to achieve said target terms.

32. The method of claim 31, wherein said actions are selected from the group consisting of political actions, economic actions, social actions, technological actions, legal actions, environmental actions, charitable actions, policy actions, regulatory actions, financial actions, and combinations thereof.

33. A method for utilizing an indicator to modify the terms of a financial instrument, said method comprising the steps of:
obtaining said indicator, wherein said indicator is based on data selected from the group consisting of non-economic industry data, location data, non-economic organization data, and combinations thereof; and
utilizing said indicator to determine at least one term of said financial instrument.

34. The method of claim 33, wherein said indicator is selected from the group consisting of letters, numbers, individual distinguishable characters, scores, ratings, indexes, and combinations thereof.

35. The method of claim 33, wherein said organization data is selected from organizations from the group consisting of non-profit organizations, for-profit organizations, governments, government agencies, non-government organizations, associations, and combinations thereof.

36. The method of claim 33, wherein said at least one term is selected from the group consisting of an interest rate, calling terms, sinking terms, redemption terms, conversion terms, maturity, penalties, refunds, escrow terms, and combinations thereof.

37. The method of claim 33, wherein said financial instrument is a debt instrument selected from the group consisting of a contractual assurance to repay in the form of a promissory note, a credit facility, a bill of exchange, a bond, a debenture, a loan, a note, an instrument of indebtedness, and combinations thereof.

38. The method of claim 33, wherein said indicator comprises a value obtained from a third party.

39. The method of claim 33, wherein said data is representative of at least one PESTLE variable selected from the group consisting of political data, economic data, social data, legal data, technological data, environmental data, and combinations thereof.

40. A method for determining settlement terms of a financial instrument based on an indicator, said method comprising the steps of:
processing a request for indebtedness from a borrower;
calculating said indicator from data selected from the group consisting of political data, social data, legal data, technological data, environmental data, questions posed to an online community, questions posed to an organization, questions posed to a third party, and combinations thereof;
assigning a time expiration for revaluation of said financial instrument, wherein said terms according to said indicator are adjusted at said time expiration;
generating a new indicator at said time expiration; and
utilizing said new indicator to revise said terms of said financial instrument upon said time expiration.

41. A method of calculating an indicator based on PESTLE variables, wherein said PESTLE variables are selected from the group consisting of political data, social data, technological data, legal data, environmental data, and combinations thereof.

42. The method of claim 41, wherein said indicator is based on at least one factor selected from the group consisting of responses to surveys, questionnaires, pick lists, votes, opinion polls, individual opinions, and combinations thereof.

43. A method of generating an indicator to determine at least one term of a financial instrument, said method comprising the steps of:
obtaining organization data, wherein said organization data comprises PESTLE data;
obtaining sentiment data, wherein said sentiment data comprises PESTLE data; and
weighting said PESTLE data, wherein said PESTLE data is weighted by a voting community.

44. A method of utilizing an indicator to modify at least one term of a financial instrument, said method comprising the steps of:
obtaining computer-generated data, wherein said data is representative of at least one PESTLE variable selected from the group consisting of political data, social data, legal data, technological data, environmental data, and combinations thereof;
obtaining weighting factors for said data;
weighting said data by said weighting factors to obtain said indicator; and
modifying said at least one term of said financial instrument based on said indicator.

45. The method of claim 44, wherein said at least one term of said financial instrument is selected from the group consisting of an issue date, an effective date, an expiration date, and combinations thereof.

46. The method of claim 44, said method further comprising the steps of:
selecting a future date for modifying said at least one term of said financial instrument; and
modifying said at least one term of said financial instrument based on a PESTLE indicator and a future indicator via a computer, wherein said PESTLE indicator and said future indicator are identified at said future date.

47. The method of claim 46, wherein said PESTLE indicator changes in numerical value during the life of said financial instrument.

48. A method for utilizing an indicator for a financial instrument, wherein a change in said indicator is based on data representative or at least one PESTLE variable selected from the group consisting of political data, social data, legal data, technological data, environmental data, and combinations thereof, and wherein said change triggers modification of at least one term of said financial instrument.

49. The method of claim 48, said method further comprising the steps of:
obtaining sentiment data from a computer, wherein said sentiment data comprises at least one PESTLE variable representative of an organization;
weighting said sentiment data by a voting community of online users to obtain a baseline indicator; and
comparing said baseline indicator to a future indicator to determine at least one output selected from the group consisting incremental valuation changes, triggering events, and combinations thereof.

50. The method of claim 49, wherein said triggering events modify predefined terms of said financial instrument.

51. The method of claim 49, wherein said future indicator is determined by the performance of an organization and based on said at least one PESTLE variable.

52. A method of utilizing an indicator and a future indicator to modify a financial instrument, said method comprising the steps of:
obtaining at least one data component from a third party wherein said at least one data component comprises at least one non-economic PESTLE variable;
attaching a weight to said at least one non-economic PESTLE variable;
calculating said indicator from said at least one non-economic PESTLE variable;
calculating said future indicator from said at least one non-economic PESTLE variable; and
comparing said indicator and said future indicator to modify at least one term of said financial instrument.

53. The method of claim 52, wherein said step of obtaining said at least one data component from said third party further comprises the steps of:
processing sentiment data related to said at least one PESTLE variable, wherein said at least one non-economic PESTLE variable is chosen by a voting community;
weighting said sentiment data; and
generating said indicator from said weighted sentiment data, wherein said indicator determines at least one term of said financial instrument.

54. A method of constructing a financial instrument, said method comprising the steps of:
generating an indicator for an organization, wherein said indicator is based on non-economic PESTLE factors;
setting a time expiration;
reevaluating said indicator during and up to said time expiration; and
generating an updated indicator at said time expiration, wherein said updated indicator is the basis for modification of at least one term of said financial instrument, and wherein said updated indicator is based on performance of said organization.

55. The method of claim 54, wherein said performance of said organization is related to said indicator.

56. The method of claim 54, wherein said performance changes numerically based on the actions of said organization.

57. A method of determining settlement terms of a financial instrument, said method comprising the steps of:
generating a baseline indicator for an organization, wherein said baseline is representative of at least one PESTLE variable selected from the group consisting of political data, social data, legal data, technological data, environmental data, and combinations thereof;
determining a time expiration related to said financial instrument;
determining a target indicator for said organization to achieve by said time expiration, wherein said target indicator is representative of at least one PESTLE variable selected from the group consisting of political data, social data, legal data, technological data, environmental data, and combinations thereof;
reevaluating said indicator at scheduled intervals; and
attaching an incremental value to said indicator at said scheduled intervals.

58. A method for creating a baseline for a financial instrument via a computer network, said method comprising the steps of:
obtaining sentiment data, wherein said sentiment data is obtained from voting and polling an online community; and
weighting said sentiment data to create said baseline.

59. The method of 58, wherein said financial instrument is selected from the group consisting of a bond, a note, a debenture, a credit facility, a loan, a barter, a fund, a transfer of capital with the expectation of return, and combinations thereof.

60. A method of determining at least one term of a financial instrument, said method comprising the steps of:
processing an indicator, wherein said indicator is representative of PESTLE data, and wherein said PESTLE data is selected from the group consisting of political data, social data, environmental data, technological data, legal data, and combinations thereof; and
determining terms of said financial instrument from said indicator.

61. The method of claim 60, wherein said indicator is further representative of economic data.

62. The method of claim 60, wherein said indicator is representative of at least one organization, and wherein said at least one organization is selected from the group consisting of non-profit organizations, profit organizations, governments, government agencies, subsidiaries, businesses, associations, and combinations thereof.

63. A method of determining the terms of a financial instrument by computing an indicator, said method comprising the steps of:
gathering responses from an on-line community, wherein said responses are representative of PESTLE data, and wherein said PESTLE data is selected from the group consisting of political data, social data, environmental data, technological data, legal data, and combinations thereof;
transforming said responses into said indicator; and
determining said terms of said financial instrument from said indicator.
